(19) United States
(12) Patent Application Publication
(10) Pub. No.: US 2026/0161287 A1
(43) Pub. Date: Jun. 11, 2026

(54) Shared reorder buffer for memory I/O responses

(71) Applicant: MELLANOX TECHNOLOGIES, LTD., Yokneam (IL)

(72) Inventors: Alon Singer, Tel Aviv (IL); Zachy Haramaty, Hemed (IL); Uria Basher, Nehusha (IL)

(21) Appl. No.: 18/976,396

(22) Filed: Dec. 11, 2024

(51) Int. Cl. G06F 3/06

(52) U.S. Cl. CPC G06F 3/0608; G06F 3/0656; G06F 3/0673

(57) ABSTRACT

In one embodiment, a system for handling out-of-order memory responses in a multi-processor environment includes a plurality of processors, a shared reorder buffer coupled to the plurality of processors, and a plurality of transaction identification (ID) assignment logic units, each associated with a respective processor of the plurality of processors, wherein each transaction ID assignment logic unit is to assign transaction IDs to memory requests issued by the respective processor, and the shared reorder buffer is to store and reorder memory responses to the memory requests based on the assigned transaction IDs.

### FIELD OF THE DISCLOSURE

The present disclosure relates to computer systems, and in particular, but not exclusively, to a shared reorder buffer for memory I/O responses.

### BACKGROUND

Modern processors often issue multiple memory requests simultaneously to enhance performance. These requests can be issued to different memory locations at varying distances from the processor. This approach allows the processor to continue executing instructions without waiting for each memory operation to complete before issuing the next one.

However, issuing multiple concurrent memory requests introduces challenges related to memory consistency and out-of-order responses. Memory consistency issues can arise when requests arrive at their targets out of program order, potentially causing problems if there are dependencies between operations. Out-of-order responses, particularly for read requests, can occur when responses return to the processor in a different order than the requests were issued.

To handle out-of-order responses, processors typically employ reorder buffers. A reorder buffer assigns transaction IDs to outgoing requests and uses these IDs to reorder responses back into the original program order before passing them to the processor. The size of a reorder buffer depends on the maximum number of outstanding requests allowed.

In systems with multiple processors, each processor has its own dedicated reorder buffer. This approach ensures that each processor can handle its own out-of-order responses independently.

### SUMMARY

There is provided in accordance with an embodiment of the present disclosure, a system for handling out of order memory responses in a multi-processor environment, the system including a plurality of processors, a shared reorder buffer coupled to the plurality of processors, and a plurality of transaction identification (ID) assignment logic units, each associated with a respective processor of the plurality of processors, wherein each transaction ID assignment logic unit is to assign transaction IDs to memory requests issued by the respective processor, and the shared reorder buffer is to store and reorder memory responses to the memory requests based on the assigned transaction IDs.

Further in accordance with an embodiment of the present disclosure, the system includes a plurality of routing logic units associated with respective processors of the plurality of processors, wherein each routing logic unit is to determine whether to send a given memory response directly to the respective processor or to the shared reorder buffer.

Still further in accordance with an embodiment of the present disclosure each routing logic unit is to send the given memory response directly to the respective processor if the given memory response corresponds to a lowest transaction ID memory response not yet been received by the respective processor.

Additionally in accordance with an embodiment of the present disclosure each routing logic unit is to send the given memory response to the shared reorder buffer if the memory response does not correspond to the lowest transaction ID memory response not yet been received by the respective processor.

Moreover, in accordance with an embodiment of the present disclosure the shared reorder buffer includes flip flops to allow simultaneous comparisons between transaction IDs of the memory responses stored in the shared reorder buffer and lowest transaction IDs per clock cycle.

Further in accordance with an embodiment of the present disclosure the shared reorder buffer includes static random-access memory (SRAM) to reduce area requirements.

Still further in accordance with an embodiment of the present disclosure, the system includes a selector to route the memory responses stored in the shared reorder buffer to appropriate ones of the processors based on initiator IDs included in the memory responses.

Additionally, in accordance with an embodiment of the present disclosure each transaction ID assignment logic unit is to maintain a First-In First-Out (FIFO) buffer of assigned transaction IDs.

Moreover, in accordance with an embodiment of the present disclosure the shared reorder buffer is configured to receive a lowest transaction ID from the FIFO buffer of each of the transaction ID assignment logic units.

Further in accordance with an embodiment of the present disclosure the shared reorder buffer is configured to send a signal to one of the transaction ID assignment logic units when a transaction ID of a given memory response received by the shared reorder buffer has a transaction ID equal to the lowest transaction ID.

Still further in accordance with an embodiment of the present disclosure the given transaction ID assignment logic unit is to update a value of the lowest transaction ID in response to the signal from the shared reorder buffer.

Additionally in accordance with an embodiment of the present disclosure the shared reorder buffer is to compare the transaction IDs of memory responses to lowest transaction IDs of respective memory responses not yet been received by respective processors of the plurality of processors.

Moreover, in accordance with an embodiment of the present disclosure the shared reorder buffer is to send to a given one of the processors, one of the memory responses having one of the transaction IDs matching one of the lowest transaction IDs of one of the respective memory responses not yet received by the given processor.

Further in accordance with an embodiment of the present disclosure the system is implemented on a single integrated circuit (IC).

Still further in accordance with an embodiment of the present disclosure the memory requests are input/output (I/O) requests to memory on the same integrated circuit (IC) as the processors.

Additionally in accordance with an embodiment of the present disclosure the shared reorder buffer is to maintain separate per processor ordering for the memory responses.

Moreover, in accordance with an embodiment of the present disclosure the shared reorder buffer does not enforce ordering between the memory responses associated with different processors.

There is also provided in accordance with another embodiment of the present disclosure, a method for handling out of order memory responses in a multi-processor environment, the method including assigning transaction IDs to memory requests issued by a plurality of processors, and storing and reordering memory responses to the memory requests based on the assigned transaction IDs in a shared reorder buffer shared for use by the plurality of processors.

Further in accordance with an embodiment of the present disclosure, the method includes determining whether to send a given memory response directly to a respective one of the plurality of processors or to the shared reorder buffer.

Still further in accordance with an embodiment of the present disclosure, the method includes routing the memory responses stored in the shared reorder buffer to appropriate ones of the processors based on initiator IDs included in the memory responses.

Additionally in accordance with an embodiment of the present disclosure, the method includes comparing the transaction IDs of memory responses to lowest transaction IDs of respective memory responses not yet been received by respective ones of the plurality of processors.

### BRIEF DESCRIPTION OF THE DRAWINGS

The present disclosure will be understood from the following detailed description, taken in conjunction with the drawings in which:

FIG. 1 is a schematic view of a memory retrieval system constructed and operative in accordance with an embodiment of the present disclosure;

FIGS. 2A-D are schematic views of part of the system of FIG. 1 illustrating processing of memory requests and memory responses;

FIG. 3 is a flowchart including steps in a method of operation of a transaction identification (ID) assignment logic unit in the system of FIG. 1;

FIG. 4 is a flowchart including steps in a method of operation of a shared reorder buffer in the system of FIG. 1;

FIG. 5 is a flowchart including steps in a method of operation of a routing logic unit in the system of FIG. 1; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW

As previously mentioned, in systems with multiple processors, each processor has its own dedicated reorder buffer. This approach ensures that each processor can handle its own out-of-order responses independently. However, as the number of processors in a system increases, the total chip area dedicated to reorder buffers can become significant.

Efficient use of chip area is a constant concern in processor design, as it impacts factors such as power consumption, heat generation, and manufacturing costs. Therefore, techniques that can reduce the total chip area required for functions like reorder buffers, while maintaining or improving performance, are of great interest in the field of processor architecture.

The utilization of individual reorder buffers in multi-processor systems is often quite low, as it is rare for all processors to simultaneously issue their maximum number of memory requests. This low utilization suggests that there may be opportunities to improve efficiency in how reorder buffer resources are allocated in multi-processor systems.

Embodiments of the present disclosure provide an efficient solution for handling out-of-order memory responses in multi-processor systems by utilizing a shared reorder buffer. In this approach, each processor retains its own transaction ID assignment logic, which assigns unique transaction IDs to outgoing requests, maintaining ordering within each processor's request stream.

In some embodiments, the system includes a single, centralized reorder buffer shared among all processors, significantly reducing the total chip area required compared to individual buffers for each processor. When responses return, intelligent routing logic checks if the response is the next expected one for its processor. If so, it bypasses the reorder buffer and goes directly to the processor; if not, it is stored in the shared reorder buffer for reordering. In some embodiments, the system includes selectors to route requests and responses to the relevant processors and logic components.

In some embodiments, to optimize performance and area usage, the shared buffer can be flexibly implemented using either flip-flops for higher performance, allowing simultaneous comparisons between transaction IDs of responses and lowest transaction IDs per clock cycle, or using SRAM for reduced area at the cost of lower performance due to sequential comparisons. The size of the shared buffer may be optimized based on expected usage patterns across all processors, for example, one-third of the combined size of memory needed for separate buffers for each processor. This scalable solution addresses the issue of low utilization of individual reorder buffers in multi-processor systems, where it is rare for all processors to simultaneously issue their maximum number of memory requests.

The per-processor routing logic may receive the lowest transaction ID from the corresponding transaction ID assignment logic. In certain embodiments, the routing logic and shared buffer may inform the transaction ID assignment logic when a memory response with a transaction ID equal to the lowest transaction ID is received, and the transaction ID assignment logic may send the new lowest transaction ID to the shared reorder buffer and routing logic. The solution is particularly suited for systems with multiple processors accessing shared memory or I/O interfaces, providing an efficient mechanism for maintaining proper ordering of responses for each individual processor while optimizing chip area usage.

In some embodiments, the processors, shared reorder buffer, transaction ID assignment logic, routing logic, and memory may be implemented on the same integrated circuit (IC).

### SYSTEM DESCRIPTION

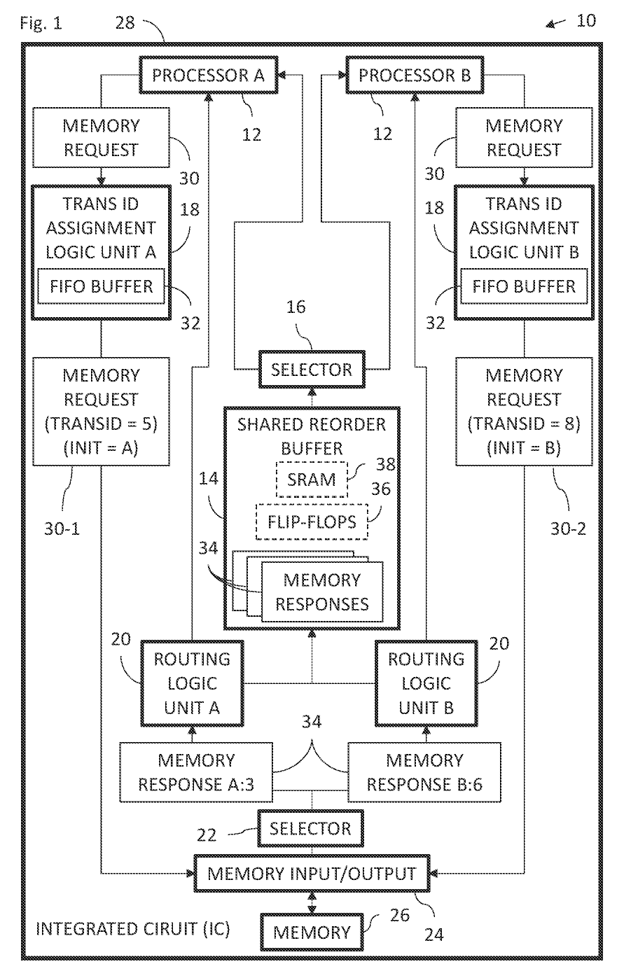

Reference is now made to FIG. 1, which is a schematic view of a memory retrieval system 10 constructed and operative in accordance with an embodiment of the present disclosure. The system 10 is configured for handling out-of-order memory responses in a multi-processor environment. The system 10 includes a plurality of processors 12, a shared reorder buffer 14 coupled to the plurality of processors 12 via a selector 16. The system may include a plurality of transaction ID assignment logic units 18, a plurality of routing logic units 20, another selector 22, a memory input/output interface 24, and a memory 26. In some embodiments, the system 10 is implemented on a single integrated circuit (IC) 28.

FIG. 1 shows two processors 12 for the sake of simplicity, namely processor A and processor B. The system 10 may include any suitable number of processors 12. Each processor 12 issues memory requests 30. In some embodiments, the memory requests 30 are input/output (I/O) requests to memory 26 (via memory input/output interface 24) on the same IC 28 as the processors 12. In some embodiments, the processors 12 and memory 26 may be disposed on different ICs.

FIG. 1 shows two transaction ID assignment logic units 18, namely, transaction ID assignment logic unit A and transaction ID assignment logic unit B, for the sake of simplicity and to correspond to the two processors 12 shown in FIG. 1. The system 10 may include any suitable number of transaction ID assignment logic units 18 corresponding to the number of processors 12. Each transaction identification (ID) assignment logic unit 18 is associated with a respective processor 12. For example, transaction ID assignment logic unit A is associated with processor A, and transaction ID assignment logic unit B is associated with processor B. Each transaction ID assignment logic unit 18 is configured to assign transaction IDs to memory requests 30 issued by the respective processor 12. For example, transaction ID assignment logic unit A is configured to assign transaction IDs to memory requests 30 issued by processor A, and transaction ID assignment logic unit B is configured to assign transaction IDs to memory requests 30 issued by processor B. The transaction ID assignment logic units 18 typically assign the transaction IDs to memory requests 30 according to a sequence of numbers (e.g., an increasing sequence). FIG. 1 shows that transaction ID assignment logic unit A has added a transaction ID equal to 5, and initiator ID equal to A, to a memory request 30-1, and that transaction ID assignment logic unit B has added a transaction ID equal to 8, and initiator ID equal to B, to a memory request 30-2. Each transaction ID assignment logic unit 18 may maintain a First-In-First-Out (FIFO) buffer 32 of assigned transaction IDs.

The memory requests 30 are provided by the transaction ID assignment logic units 18 to the memory input/output interface 24 which processes the memory requests 30 with respect to memory 26. The memory input/output interface 24 generates memory responses 34 corresponding to the memory requests 30, and provides the memory responses 34 to selector 22.

The memory responses 34 are processor-specific just as the memory requests 30 are processor-specific. For example, a memory response 34 to processor A is generated in response to a memory request 30 from processor A, and so on.

FIG. 1 shows two routing logic units 20, namely, routing logic unit A and routing logic unit B, for the sake of simplicity and to correspond to the two processors 12 shown in FIG. 1. The routing logic units 20 are associated with respective processors 12, such that each routing logic unit 20 is associated with a respective processor 12. For example, routing logic unit A is associated with processor A, and routing logic unit B is associated with processor B.

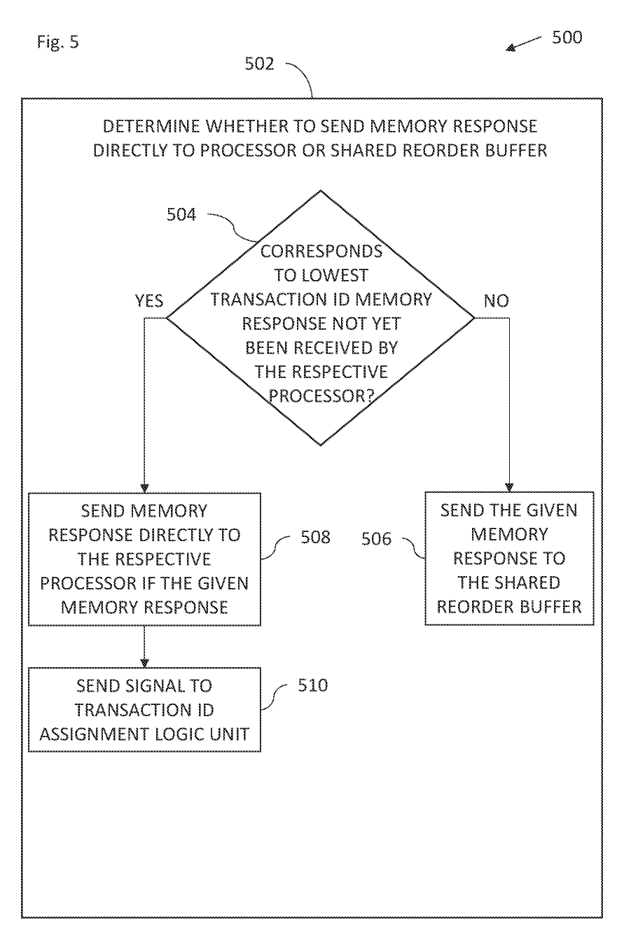

The selector 22 is configured to provide the memory responses 34 to the relevant routing logic units 20. For example, the selector 22 provides memory responses 34 (to memory requests 30 generated by processor A) to routing logic unit A, and memory responses 34 (to memory requests 30 generated by processor B) to routing logic unit B. Each routing logic unit 20 is configured to determine whether to send a given memory response 34 directly to the respective processor 12 or to the shared reorder buffer 14, as described in more detail with reference to FIG. 5.

The shared reorder buffer 14 is configured to store and reorder memory responses 34 to the memory requests 30 based on the assigned transaction IDs of the memory responses 34. The memory responses 34 retain the same transaction IDs and initiator IDs that were assigned to the respective memory requests 30 to which the memory responses 34 are responsive. The shared reorder buffer 14 includes memory responses 34 for different processors 12 and is configured to maintain separate per-processor ordering for the memory responses 34. The memory responses 34 do not enforce ordering between the memory responses 34 associated with different processors 12. For example, the shared reorder buffer 14 is configured to reorder the memory responses 34 for processor A independently of reordering the memory responses 34 for processor B.

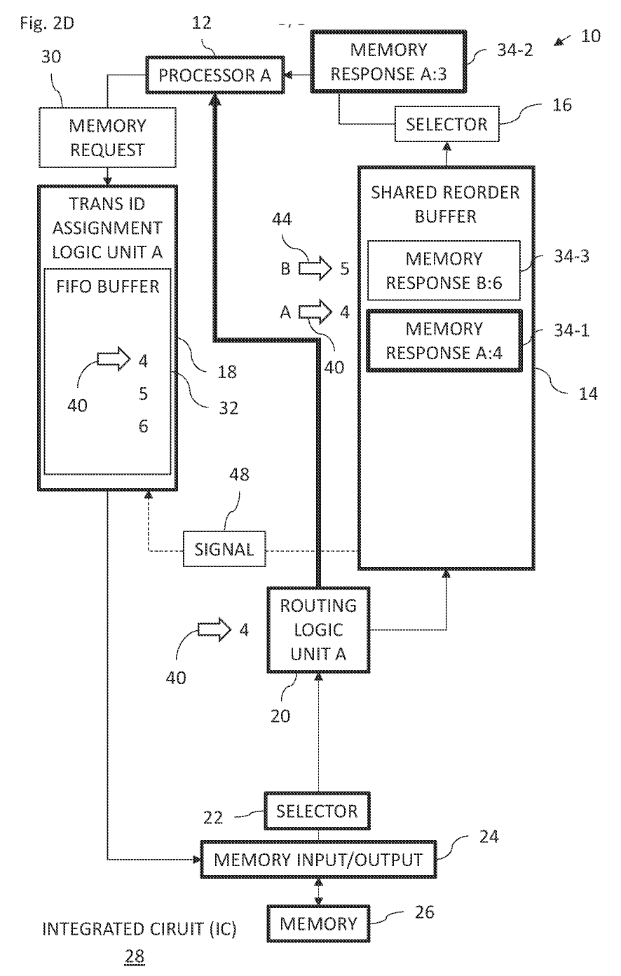

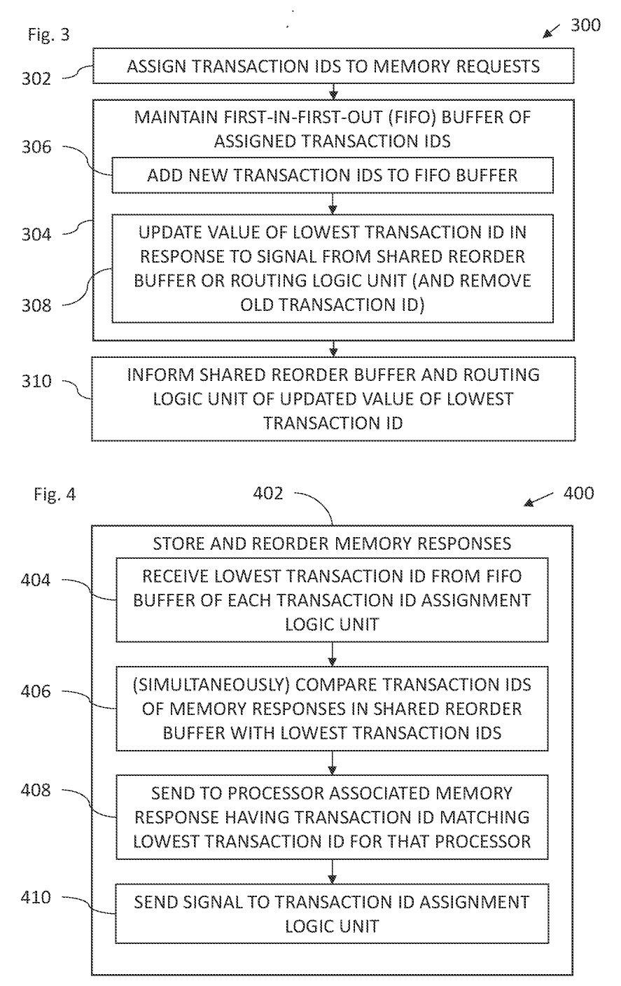

In some embodiments, the shared reorder buffer 14 includes flip-flops 36 to allow simultaneous comparisons between transaction IDs of the memory responses 34 stored in the shared reorder buffer 14 and lowest transaction IDs per clock cycle. In some embodiments, the shared reorder buffer 14 includes static random-access memory (SRAM) 38 to reduce area requirements on IC 28. The shared reorder buffer 14 is described in more detail with reference to FIG. 3.

The shared reorder buffer 14 provides reordered memory responses 34 to selector 16, which is configured to route the memory responses 34 previously stored in the shared reorder buffer 14 to the appropriate processor 12 based on the initiator IDs included in the memory responses 34. For example, memory responses 34 with initiator ID A are provided by selector 16 to processor A, and memory responses 34 with initiator ID B are provided by selector 16 to processor B.

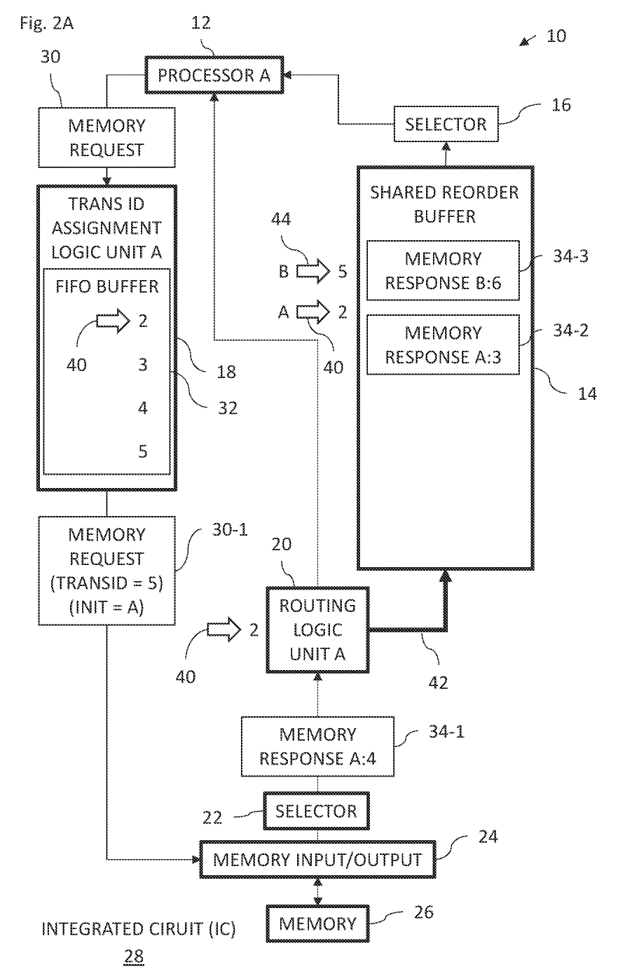

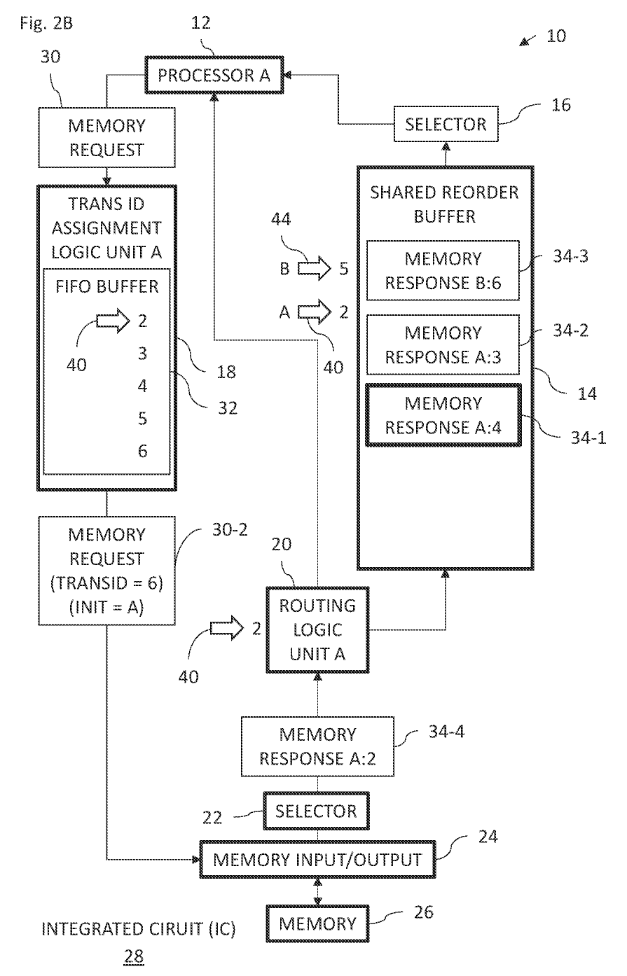

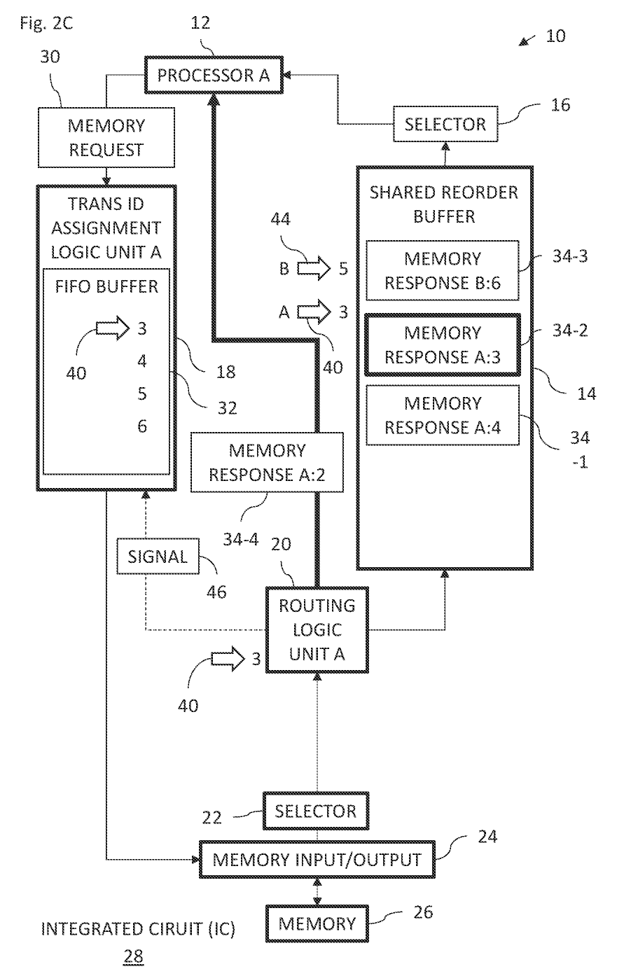

Reference is now made to FIGS. 2A-D, which are schematic views of part of the system 10 of FIG. 1 illustrating processing of memory requests 30 and memory responses 34. FIGS. 2A-D show one of the processors 12, i.e., processor A, and a corresponding one of the transaction ID assignment logic units 18, i.e., transaction ID assignment logic unit A, and a corresponding one of the routing logic units 20, i.e., routing logic unit A. FIGS. 2A-D also show shared reorder buffer 14, selector 16, selector 22, memory input/output interface 24, and memory 26. illustrate how memory requests 30 generated by processor A are processed by transaction ID assignment logic unit A (and its FIFO buffer 32), and how corresponding memory responses 34 (i.e., responses to memory requests 30 generated by processor A) are processed by routing logic unit A, and shared reorder buffer 14.

FIG. 2A shows that transaction ID assignment logic A has assigned transaction ID equal to 5 and initiator ID equal to A (i.e., the initiator is processor A) to memory request 30-1. As transaction IDs are assigned to memory requests 30, the corresponding transaction IDs are added to FIFO buffer 32, and as memory responses 34 are provided to processor A by the shared reorder buffer 14 or by routing logic unit A, the corresponding transaction IDs are removed from FIFO buffer 32, for example, in response to signals sent by routing logic unit A or shared reorder buffer 14 as described in more detail below with reference to FIGS. 2C-D. For example, when transaction ID equal to 5 is assigned to a memory request 30-1, transaction ID equal to 5 is added to FIFO buffer 32 by transaction ID assignment logic unit A, and when one of the memory responses 34 with transaction ID equal to X is provided to processor A, transaction ID equal to X is removed from FIFO buffer 32. FIFO buffer 32 is configured to track the lowest transaction ID (arrow 40) for use by routing logic unit A and shared reorder buffer 14 as described in more detail below. FIG. 2A illustrates that transaction ID assignment logic A has previously assigned transaction IDs 0 to 4 to other memory requests 30, and memory requests 30 with IDs equal to 0 and 1 have corresponding memory responses 34 which have been provided to processor A. Therefore, FIFO buffer 32 shows transaction IDs 2-5 with the lowest transaction ID equal to 2 (arrow 40). Transaction ID assignment logic unit A provides memory request 30-1 to memory input/output interface 24 for processing.

FIG. 2A also shows that a memory response 34-1 for initiator A (i.e., processor A) and transaction ID equal to 4 has been provided by memory input/output interface 24 via selector 22 to routing logic unit A. Routing logic unit A and shared reorder buffer 14 have knowledge of the lowest transaction ID (arrow 40) for initiator A, for which a corresponding memory request 30 has been issued to memory input/output interface 24, but a corresponding memory response 34 has not yet been received by processor A. In general, the term “lowest transaction ID” for a given initiator, is the lowest transaction ID from which a corresponding memory request 30 has been issued to memory input/output interface 24, but a corresponding memory response 34 has not yet been received by the given initiator.

In the example of FIG. 2A, the lowest transaction ID (arrow 40) for initiator A, is equal to 2. Routing logic A compares the transaction ID (equal to 4) of the received memory response 34-1 to the lowest transaction ID (equal to 2). If the transaction ID of the received memory response 34-1 is equal to the lowest transaction ID, routing logic A provides the memory response 34-1 to processor A. However, as the transaction ID of the received memory response 34-1 is not equal to the lowest transaction ID, routing logic A provides (arrow 42) the memory response 34-1 to shared reorder buffer 14 (as illustrated in FIG. 2B).

Prior to memory response 34-1 arriving in shared reorder buffer 14, shared reorder buffer 14 includes two memory responses 34, namely memory response 34-2 and memory response 34-3. Memory response 34-2 is a memory response for initiator ID equal to A (i.e., processor A) and transaction ID equal to 3, and memory response 34-3 is a memory response for initiator ID equal to B (i.e., processor B) and transaction ID equal to 6. In practice, shared reorder buffer 14 may handle memory responses 34 for other initiators (i.e., other processors 12) and the shared reorder buffer 14 at any time may include memory responses 34 from some or all of the different initiators (i.e., processors 12) in system 10. FIG. 2A shows that the lowest transaction ID (arrow 40) for initiator A is equal to 2, and the lowest transaction ID (arrow 44) for initiator B is equal to 5. The shared reorder buffer 14 compares the lowest transaction ID per initiator to the memory responses 34 in shared reorder buffer 14 of that initiator. For example, shared reorder buffer 14 compares the lowest transaction ID for initiator A (i.e., processor A), equal to 2 in the example of FIG. 2A, to the transaction ID(s) of the memory response(s) 34 for initiator A (e.g., memory response 34-2) in shared reorder buffer 14 and because the transaction ID (equal to 3 in the example of FIG. 2A) of the memory response(s) 34 for initiator A (e.g., memory response 34-2) is greater than the lowest transaction ID for initiator A, none of the memory responses 34 for initiator A in shared reorder buffer 14 are provided by shared reorder buffer 14 to initiator A (i.e., processor A). Similarly, shared reorder buffer 14 compares the lowest transaction ID for initiator B (i.e., processor B), equal to 5 in the example of FIG. 2A, to the transaction ID(s) of the memory response(s) 34 for initiator B (e.g., memory response 34-3) in shared reorder buffer 14 and because the transaction ID (equal to 6 in the example of FIG. 2A) of the memory response(s) 34 for initiator B (e.g., memory response 34-3) is greater than the lowest transaction ID for initiator B, none of the memory responses 34 for initiator B in shared reorder buffer 14 are provided by shared reorder buffer 14 to initiator B (i.e., processor B). The above comparison of the lowest transaction IDs to the transaction IDs of the memory responses 34 in shared reorder buffer 14 may occur in a single clock cycle (e.g., if the shared reorder buffer 14 includes flip-flops 36 (FIG. 1)), or in multiple clock cycles (e.g., if the shared reorder buffer 14 includes SRAM 38 (FIG. 1).

FIG. 2B shows that memory response 34-1 is now residing in shared reorder buffer 14. FIG. 2B also shows that transaction ID assignment logic A has assigned transaction ID equal to 6 and initiator ID equal to A (i.e., the initiator is processor A) to memory request 30-2. Transaction ID assignment logic unit A also adds transaction ID equal to 6 to FIFO buffer 32. FIG. 2B illustrates that transaction ID assignment logic A has previously assigned transaction IDs 0 to 5 to other memory requests 30, and memory requests 30 with IDs equal to 0 and 1 have corresponding memory responses 34 which have been provided to processor A. Therefore, FIFO buffer 32 shows transaction IDs 2-6 with the lowest transaction ID equal to 2. Transaction ID assignment logic unit A provides memory request 30-2 to memory input/output interface 24 for processing.

FIG. 2B also shows that a memory response 34-4 for initiator A (i.e., processor A) and transaction ID equal to 2 has been provided by memory input/output interface 24 via selector 22 to routing logic unit A. In the example of FIG. 2B the lowest transaction ID (arrow 40) for initiator A, is equal to 2. Routing logic A compares the transaction ID (equal to 2) of the received memory response 34-4 to the lowest transaction ID (equal to 2), and because the transaction ID of the received memory response 34-4 is equal to the lowest transaction ID, routing logic A provides the memory response 34-1 to processor A.

FIG. 2C shows that routing logic A has provided the memory response 34-4 to processor A. In some embodiments, routing logic A sends a signal 46 to transaction ID assignment logic unit A informing transaction ID assignment logic unit A that one of the memory responses 34 with a given transaction ID (equal to 2 in the example of FIG. 2C) has been provided to processor A. The transaction ID assignment logic unit A updates FIFO buffer 32 to remove the transaction ID (equal to 2) of memory response 34-4 from FIFO buffer 32 thereby updating the FIFO buffer 32 and assigning a new lowest transaction ID equal to 3 (arrow 40). In response to updating FIFO buffer 32, transaction ID assignment logic unit A informs the shared reorder buffer 14 and routing logic A regarding the value of the new lowest transaction ID, equal to 3.

FIG. 2C shows that the lowest transaction ID (arrow 40) for initiator A is now equal to 3, and the lowest transaction ID (arrow 44) for initiator B is still equal to 5. The shared reorder buffer 14 compares the lowest transaction ID per initiator to the memory responses 34 in shared reorder buffer 14 of that initiator. For example, shared reorder buffer 14 compares the lowest transaction ID for initiator A (i.e., processor A), equal to 3 in the example of FIG. 2C, to the transaction IDs of the memory responses 34 for initiator A (e.g., memory responses 34-1, 34-2) in shared reorder buffer 14 and because the transaction ID of the memory response 34-2 for initiator A is equal to the lowest transaction ID for initiator A, shared reorder buffer 14 provides memory response 34-2 to processor A via selector 16, as shown in FIG. 2D.

FIG. 2D shows that memory response 34-2 has been provided by shared reorder buffer 14 via selector 16 to processor A. In some embodiments, shared reorder buffer 14 sends a signal 48 to transaction ID assignment logic unit A informing transaction ID assignment logic unit A that one of the memory responses 34 with a given transaction ID (equal to 3 in the example of FIG. 2D) has been provided to processor A. The transaction ID assignment logic unit A updates FIFO buffer 32 to remove the transaction ID (equal to 3) of memory response 34-2 from FIFO buffer 32 thereby updating the FIFO buffer 32 and assigning a new lowest transaction ID equal to 4 (arrow 40). In response to updating FIFO buffer 32, transaction ID assignment logic unit A informs the shared reorder buffer 14 and routing logic A regarding the value of the new lowest transaction ID, equal to 4.

FIG. 2D shows that the lowest transaction ID (arrow 40) for initiator A is now equal to 4, and the lowest transaction ID (arrow 44) for initiator B is still equal to 5. The shared reorder buffer 14 compares the lowest transaction ID per initiator to the memory responses 34 in shared reorder buffer 14 of that initiator. For example, shared reorder buffer 14 compares the lowest transaction ID for initiator A (i.e., processor A), equal to 4 in the example of FIG. 2D, to the transaction ID of the memory response(s) 34 for initiator A (e.g., memory responses 34-1) in shared reorder buffer 14 and because the transaction ID of the memory response 34-1 for initiator A is equal to the lowest transaction ID for initiator A, shared reorder buffer 14 provides memory response 34-1 to processor A via selector 16.

Reference is now made to FIG. 3, which is a flowchart 300 including steps in a method of operation of transaction ID assignment logic units 18 in the system 10 of FIG. 1. Each transaction ID assignment logic unit 18 is configured to assign transaction IDs to memory requests 30 issued by the respective processor 12 (block 302). For example, transaction ID assignment logic unit A issues transaction IDs to memory requests 30 issued by processor A, transaction ID assignment logic unit B issues transaction IDs to memory requests 30 issued by processor B, and so on. Each transaction ID assignment logic unit 18 is configured to maintain its FIFO buffer 32 of assigned transaction IDs (block 304). Each transaction ID assignment logic unit 18 is configured to add transaction IDs to its FIFO buffer 32 in response to that transaction ID assignment logic unit 18 assigning transactions IDs to memory requests 30 (block 306). Each transaction ID assignment logic unit 18 is configured to remove the lowest transaction ID from its FIFO buffer 32 thereby updating the value of the lowest transaction ID in response to receiving a signal from the corresponding routing logic unit 20 or from shared reorder buffer 14 (block 308) and inform the corresponding routing logic unit 20 and/or shared reorder buffer 14 of the updated value of the lowest transaction ID (block 310).

Reference is now made to FIG. 4, which is a flowchart 400 including steps in a method of operation of shared reorder buffer 14 in the system 10 of FIG. 1. Shared reorder buffer 14 is configured to store and reorder memory responses 34 to the memory requests 30 based on the assigned transaction IDs of the corresponding memory responses 34 (block 402). Shared reorder buffer 14 is configured to intermittently receive the lowest transaction ID (e.g., when the lowest transaction ID is updated) from the FIFO buffer 32 of each transaction ID assignment logic unit 18 (block 404). Shared reorder buffer 14 is configured to compare the transaction IDs of memory responses (in shared reorder buffer 14) to lowest transaction IDs of respective memory responses not yet been received by respective processors of the plurality of processors (block 406). In other words, shared reorder buffer 14 compares the lowest transaction ID per initiator to the memory responses 34 in shared reorder buffer 14 of that initiator. In some embodiments, the shared reorder buffer 14 includes flip-flops 36 configured to allow simultaneous comparisons between transaction IDs of the memory responses 34 stored in the shared reorder buffer 14 and lowest transaction IDs per clock cycle. For each memory response 34 in the shared reorder buffer 14 that matches the lowest transaction ID for the initiator of that memory response 34, the shared reorder buffer 14 is configured to send that memory response 34 to the initiator (i.e. processor 12) of that memory response 34 (block 408). For each memory response 34 in the shared reorder buffer 14 that matches the lowest transaction ID for the initiator of that memory response 34, the shared reorder buffer 14 is configured to send a signal to the transaction ID assignment logic unit 18 associated with the initiator (i.e., processor 12) of that memory response 34 (block 410) in order to inform that transaction ID assignment logic unit 18 to update the value of its lowest transaction ID as described above with reference to FIG. 3 in the steps of blocks 308 and 310.

Reference is now made to FIG. 5, which is a flowchart 500 including steps in a method of operation of one of the routing logic units 18 in the system 10 of FIG. 1. Each routing logic unit 18 is configured to determine whether to send a given memory response 34 (that is received from memory input/output interface 24 via selector 22) directly to the respective processor 12 or to the shared reorder buffer 14 (block 502).

At a decision block 504, each routing logic unit 20 is configured to check whether the memory response 34 received from memory input/output interface 24 via selector 22 has a transaction ID, which corresponds to (i.e. equals to) the lowest transaction ID for that routing logic unit 20 (i.e., the lowest transaction ID of the memory response(s) 34 not yet received by the respective processor 12 associated with that routing logic unit 20.

If the memory response 34 received by the routing logic unit 20 does not correspond to (i.e., equal) the lowest transaction ID memory response not yet been received by the respective processor 12, that routing logic unit 20 is configured to send the received memory response 34 to shared reorder buffer 14 (block 506).

If the memory response 34 received by the routing logic unit 20 corresponds to (i.e., equals) the lowest transaction ID memory response not yet been received by the respective processor 12, that routing logic unit 20 is configured to send the given memory response 34 directly to the respective processor 12 (block 508) and send a signal to the transaction ID assignment logic unit 18 associated with the received memory response 34 (block 510).

In practice, some or all of the functions of system 10 may be combined in a single physical component or, alternatively, implemented using multiple physical components. These physical components may comprise hard-wired or programmable devices, or a combination of the two. In some embodiments, at least some of the functions of system 10 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

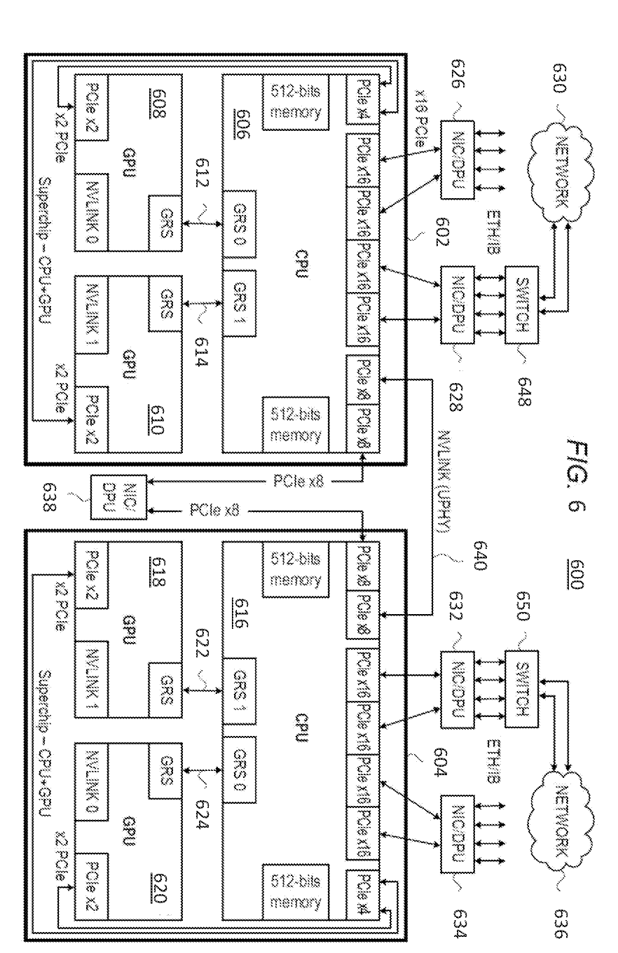

Reference is now made to FIG. 6, which is a block diagram that schematically illustrates a computing system 600, e.g., a data center or a High-Performance Computing (HPC) cluster, in accordance with an embodiment of the present disclosure. In some embodiments, system 10 may be incorporated into any of the devices described in computing system 600.

System 600 comprises a plurality of subsystems, e.g. multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

The flowchart and block diagrams in the Figures illustrate the architecture, functionality, and operation of possible implementations of systems, and methods according to various examples of the present disclosure. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system for handling out-of-order memory responses in a multi-processor environment, the system comprising:
a plurality of processors;
a shared reorder buffer coupled to the plurality of processors; and
a plurality of transaction identification (ID) assignment logic units, each associated with a respective processor of the plurality of processors, wherein:
each transaction ID assignment logic unit is to assign transaction IDs to memory requests issued by the respective processor; and
the shared reorder buffer is to store and reorder memory responses to the memory requests based on the assigned transaction IDs.

2. The system according to claim ‎1, further comprising a plurality of routing logic units associated with respective processors of the plurality of processors, wherein each routing logic unit is to determine whether to send a given memory response directly to the respective processor or to the shared reorder buffer.

3. The system according to claim ‎2, wherein each routing logic unit is to send the given memory response directly to the respective processor if the given memory response corresponds to a lowest transaction ID memory response not yet been received by the respective processor.

4. The system according to claim ‎3, wherein each routing logic unit is to send the given memory response to the shared reorder buffer if the memory response does not correspond to the lowest transaction ID memory response not yet been received by the respective processor.

5. The system according to claim ‎1, wherein the shared reorder buffer includes flip-flops to allow simultaneous comparisons between transaction IDs of the memory responses stored in the shared reorder buffer and lowest transaction IDs per clock cycle.

6. The system according to claim ‎1, wherein the shared reorder buffer includes static random-access memory (SRAM) to reduce area requirements.

7. The system according to claim ‎1, further comprising a selector to route the memory responses stored in the shared reorder buffer to appropriate ones of the processors based on initiator IDs included in the memory responses.

8. The system according to claim ‎1, wherein each transaction ID assignment logic unit is to maintain a First-In-First-Out (FIFO) buffer of assigned transaction IDs.

9. The system according to claim ‎8, wherein the shared reorder buffer is configured to receive a lowest transaction ID from the FIFO buffer of each of the transaction ID assignment logic units.

10. The system according to claim ‎9, wherein the shared reorder buffer is configured to send a signal to one of the transaction ID assignment logic units when a transaction ID of a given memory response received by the shared reorder buffer has a transaction ID equal to the lowest transaction ID.

11. The system according to claim ‎10, wherein the given transaction ID assignment logic unit is to update a value of the lowest transaction ID in response to the signal from the shared reorder buffer.

12. The system according to claim ‎1, wherein the shared reorder buffer is to compare the transaction IDs of memory responses to lowest transaction IDs of respective memory responses not yet been received by respective processors of the plurality of processors.

13. The system according to claim ‎12, wherein the shared reorder buffer is to send to a given one of the processors, one of the memory responses having one of the transaction IDs matching one of the lowest transaction IDs of one of the respective memory responses not yet received by the given processor.

14. The system according to claim ‎1, wherein the system is implemented on a single integrated circuit (IC).

15. The system according to claim ‎1, wherein the memory requests are input/output (I/O) requests to memory on a same integrated circuit (IC) as the processors.

16. The system according to claim ‎1, wherein the shared reorder buffer is to maintain separate per-processor ordering for the memory responses.

17. The system according to claim ‎16, wherein the shared reorder buffer does not enforce ordering between the memory responses associated with different processors.

18. A method for handling out-of-order memory responses in a multi-processor environment, the method comprising:
assigning transaction IDs to memory requests issued by a plurality of processors; and
storing and reordering memory responses to the memory requests based on the assigned transaction IDs in a shared reorder buffer shared for use by the plurality of processors.

19. The method according to claim ‎18, further comprising determining whether to send a given memory response directly to a respective one of the plurality of processors or to the shared reorder buffer.

20. The method according to claim ‎18, further comprising routing the memory responses stored in the shared reorder buffer to appropriate ones of the processors based on initiator IDs included in the memory responses.

21. The method according to claim ‎18, further comprising comparing the transaction IDs of memory responses to lowest transaction IDs of respective memory responses not yet been received by respective ones of the plurality of processors.
